(19) United States
(12) Patent Application Publication
(10) Pub. No.: US 2013/0121494 A1
(43) Pub. Date: May 16, 2013

(54) Ear Coupling Status Sensor

(71) Applicant: Timothy Johnston, Los Gatos, CA (US)

(72) Inventor: Timothy Johnston, Los Gatos, CA (US)

(73) Assignee: Plantronics, Inc., Santa Cruz, CA (US)

(21) Appl. No.: 13/296,415

(22) Filed: Nov. 15, 2011

(51) Int. Cl. H04R 29/00

(52) U.S. Cl. 381/56

(57) ABSTRACT

A system and method configured to determine if a user is appropriately wearing an audio device, such as a headset, is described that enables a more accurate calculation of the audio device's acoustical characteristics. Headsets, such as headphones and earbuds, include a plurality of engagement sensors configured to determine if the audio device is engaged with the user's body. Engagement sensors may comprise capacitive sensors configured to communicate their state to an engagement sensor processing circuit, which may be located in a digital signal processor. If the engagement sensor processing circuit determines that the audio device is properly engaged with the user's body, then the circuit sends a signal that engages the calculation of various audio device acoustical quality calculations that among other things may satisfy various regulatory requirements and may also lead to an improved user experience.

### FIELD

Embodiments of the invention relate to systems and methods for audio communications. More particularly, an embodiment of the invention relates to systems and methods that provide audio communications using body-worn, ear-touching, sound-transmitting audio devices, such as headsets, headphones, and earbuds.

### BACKGROUND

Noise outputs from audio devices, such as headsets, can pose a health risk to their users under certain circumstances. The accumulated amount of noise, or dose in terms of an average noise level, and the maximum level of noise to which an individual has been exposed during a day are strictly regulated in many countries. For example, maintaining workplace noise safety standards is a core function for agencies such as the Occupational Safety and Health Administration (OSHA) in the United States.

Headset users in the workplace typically have jobs that either require they spend a substantial amount of time on the telephone and/or that their hands be free to perform other tasks. Since the headset user's speaker is held in or against the user's ear, the user requires more time to respond to any irritating tones or noises by moving the speaker further away from the ear than one typically does with a regular telephone handset. Accordingly, headset users can be exposed to sounds which may be irritating and even very loud. Such exposure is referred to in the art as “acoustic incidents.”

Noise exposure may be measured by various acoustical quality calculations, such as impulse noise, continuous noise, and an eight-hour time-weighted average (“TWA”) that is also referred to as “daily personal noise exposure.” Impulse noise relates to noise of very short duration. Continuous noise relates to noise that is longer in duration than impact noise, extending longer than 500 milliseconds. Eight-hour TWA relates to the average of all levels of impulse and continuous noise to which a person is exposed during an eight-hour period. The OSHA maximum level for impulse noise is 140 dBSPL measured with a fast peak-hold sound level meter (“dBSPL” stands for sound pressure level, or a magnitude of pressure disturbance in air, measured in decibels, which is a logarithmic scale). The maximum level for continuous noise is 115 dB(A) (read on the slow average “A” scale). OSHA regulations limit an eight-hour TWA to 90 dB(A). Other countries typically maintain different regulations and standards with respect to noise exposure.

Telephones and headsets comprise difficult devices to monitor for excessive noise exposure. Standard noise exposure measurement procedures described in the United States Code of Federal Regulations at 29 CFR 1910.95 and International Organization for Standardization (ISO) 1999 are performed for open-field environmental noise that can be measured with a sound level meter. An “open-field” environment is an environment where the sound or noise sources are at a distance from a person's ear. The sound or noise environment can be a single or a combination of many acoustic fields, i.e. free field, partially reflected field, diffuse field and reverberant field. Noise exposure from a headset is different from the “open-field” because the sound is localized at or inside of the user's ear. Accordingly, an acoustic analyst must transfer the measured earphone or headset sound pressure levels to the “open-field” before comparing them to the regulatory TWA noise exposure limits.

Performing acoustical quality calculations for a headset, often done using digital signal processor (DSP), allows the headset to determine the output signal of a transducer accurately. However, certain assumptions are typically made regarding how well or poorly the headset ear interface couples to the ear. This universal noise exposure calculation evaluates daily personal noise exposure compliant with either USA (ANSI S1.25) or International (ISO 1999) measurement standards. The choice depends on the national legislation that applies in the region where a product will be sold, such as 29 CFR 1910.95 for the United States or Directive 2003/10/EC of the European Parliament and the Council of the European Union.

Unified communications represents an important component of productivity in contemporary business culture, and its success from company to company can serve as a bellwether indicator of the company's overall management success. An essential feature behind unified communications is the ability to have a single way for reaching an employee. Thus, in a fully configured unified communications environment, all messages to an employee, regardless of the format of their origin (e.g., e-mail) will reach the employee at the earliest possible moment via another format (e.g., SMS) if necessary. The importance of appropriate audio communications in a unified communications context cannot be understated. Thus, users need the high quality headsets, and a key factor of quality is safety. In addition, some conventional schemes related to safety have a tendency to dampen sound output overtime.

Audio communications represent one of the most important (if not the most important) component of unified communications. As such a critical component in the success of unified communications, headset devices must not only achieve applicable safety standards, they must also do so in a manner that does not degrade the device's performance. As noted above, compliance with certain safety measures has sometimes had the effect of reducing a headset's operating capabilities far more than necessary or warranted.

Thus, a solution to longstanding problems related to safety compliance and the related computation of acoustical quality is called for not only for general audio applications but especially for communications arising in a business context. A simple and robust solution for this problem is in order and highly desired by a sometimes frustrated community of users and business interests. Attempts to solve this longstanding problem in the prior art have tended to be overly simplistic, overly complicated, and/or overly expensive.

### SUMMARY OF THE INVENTION

Embodiments of the invention provide an audio device configured to engage acoustical quality calculations based on a user wearing state. The audio device comprises a plurality of engagement sensors attached to the audio device. Each engagement sensor is configured to measure a worn state, where each measured worn state indicates whether the audio device touches a portion of the user's body. The engagement sensors are further configured to transmit the worn state to an engagement sensor processing circuit. The engagement sensor processing circuit is configured to receive a plurality of worn states from the plurality of engagement sensors, determine if the user is wearing the audio device based on analysis of the plurality of worn states, and engage acoustical quality calculations for the audio device if the user is determined to be wearing the audio device.

Embodiments of the invention ilk provide a method for initiating acoustical quality calculations in an audio device based on a user wearing state. The method comprises measuring a worn state by each engagement sensor of a plurality of engagement sensors attached to the audio device, wherein the worn state represents the engagement sensor's proximity to the user's body. Each engagement sensor of the plurality of engagement sensors is configured to transmit measurement data to an engagement sensor processing circuit. An engagement sensor processing circuit is configured to determine if the user is wearing the audio device by determining that each engagement sensor of the plurality of engagement sensors reports that the audio device is engaged with the user's body. The engagement sensor processing circuit is configured to engage acoustical quality calculations for the audio device if the engagement sensor processing circuit determines that the audio device is in a worn state.

### BRIEF DESCRIPTION OF THE DRAWINGS

FIG. 1A illustrates a headphone system 100 comprising a headphone 125 having a plurality of engagement sensors 105-109, according to an embodiment of the invention;

FIG. 1B illustrates relative and overlapping coverage ranges 113-117 for the engagement sensors 105-109 of the headphone system 100, according to an embodiment of the invention;

FIG. 2A illustrates an embodiment of a headphone system 200 having five engagement sensors 205-213, according to an embodiment of the invention;

FIG. 2B illustrates relative and overlapping ranges 217-225, associated with the five engagement sensors 205-213 of the headphone system 200, according to an embodiment of the invention;

FIGS. 3A-3B illustrate two views of an earbud system 300 having three engagement sensors 305-309, according to an embodiment of the invention;

FIG. 3C illustrates a sealed cavity 330 formed by inserting a portion 319 of the earbud 301 into the user's ear canal 325, according to an embodiment of the invention;

FIG. 4 illustrates a dual headphone system 400 having six engagement sensors 403-413 on a headphone 401 having two earpieces 415, 417, according to an embodiment of the invention;

FIG. 5 illustrates a digital signal processor (DSP) 500 configured to provide digital signal processing of audio signals destined for output to a headphone's speaker(s) and configured to process signals received from engagement sensors associated with headphones and earbuds, according to an embodiment of the invention;

FIG. 6 provides a flowchart 600 that shows processing logic carried out by the DSP 500 shown in FIG. 5 related to the processing of signals from engagement sensors, according to an embodiment of the invention;

FIG. 7 illustrates an engagement sensor processing circuit 700 configured to process signals received from engagement sensors, according to an embodiment of the invention; and

FIG. 8 illustrates a help screen 800 provided to users whose headsets have been determined to not be worn in an optimal manner, according to an embodiment of the invention.

### DETAILED DESCRIPTION OF AN EMBODIMENT OF THE INVENTION

Embodiments of the invention provide a capability for determining if a user is wearing an audio device appropriately, which may permit more accurate acoustical quality calculations related to device safety and may facilitate better quality sound delivery. For example, embodiments of the invention may facilitate acoustical quality calculations such as the adjustment of sound pressures in the audio device, turning on/off active noise cancellation, turning on/off computation of time weighted average (TWA) of sound data, and/or adjusting frequency of response in situations where a less-than-complete coupling is occurring. Embodiments of the invention relate to body-worn, ear proximity (or ear touching), sound transmitting devices, e.g. earbuds and headphones. Applicable audio devices are not limited to just headphones and earbuds.

Embodiments of the invention may proactively improve the seal between the user's body (e.g., head or ear) and the audio device. If the audio device is not properly worn, embodiments of the invention trigger notification to the user so that the user may perform corrective measures. For headphones, embodiments of the invention work to improve the headphone-to-head seal while for earbuds, embodiments of the invention work to improve the earbud-to-ear seal. Status notification to the user may be visual and/or verbal, according to embodiments of the invention. Similarly, status notifications may be positive or negative (e.g., “device properly worn,” or “device improperly worn,”) according to embodiments of the invention.

Knowledge by the audio device of its appropriate engagement with the user's body provides information that may be used for several purposes, according to embodiments of the invention. If the audio device is properly worn, then associated device equipment (e.g., a digital signal processor) may more accurately perform acoustical quality calculations, such as those associated with various health and safety standards. As discussed below, knowledge of the engagement (or non-engagement) of the audio device with the user's body, according to embodiments of the invention, may enable:
Turning on/off TWA; and/or
Turning on/off active noise cancellation; and/or
Adjustment of sound pressures in the headphone/earpiece commensurate with the level of engagement with the user's head; and/or
Adjustment of the frequency response in the headphone/earpiece commensurate with the level of engagement with the user's head, and/or
Application of one or more frequency shaping algorithms; and/or
Providing an appropriate status indication to the user of device's worn state.

Among other things, embodiments of the invention enable more accurate TWA calculations of acoustic data which in turn enables consistent loudness in the audio device (e.g., the headset). Embodiments of the invention may also reduce the likelihood of a headset becoming unnecessarily quiet due to sound quality being degraded by unexpected leakage. Embodiments of the invention may also further enable improved sound quality tunings that are more consistent than have conventionally been available. Embodiments of the invention enable other acoustical quality calculations, such as more accurate and meaningful tunings and sound pressure analysis of an audio device (e.g., a headset) by the device's digital signal processor (DSP).

Many assumptions have conventionally been made regarding the headset-to-ear coupling, e.g. the level of leakage which has conventionally resulted in sub-optimal device performance. Embodiments of the invention enable the audio device to detect if the device-to-body connection provides a “completely touching” and/or “sealed” interface. If the connection is sealed, then the audio device may begin its acoustical quality calculations, including performing time-weighted averaging (TWA) calculations. If the connection is not appropriately sealed, then various remedial actions may be taken.

In conventional acoustical quality calculations, TWA analysis has been based on data that is less-than-optimal because these equations did not have an adequate mechanism for knowing when the user was actually wearing the headset and/or wearing the headset properly and/or the degree to which the user was wearing the headset properly/improperly. Conventional TWA analysis sometimes resulted in using worst-case calculations that prematurely concluded the user was risking over exposure to sound pressure, which had the effect of gradually lowering certain maximum sound outputs that could be provided to the user. When performed inappropriately, these computations resulted in an audio device whose sound outputs were unnecessarily quiet.

A hermetically sealed interface ideally provides the best predictive sound pressure calculations. However, due to variations in ear shapes, sizes, elasticity, don/doff location, and wearing state variations, there are often significant variations in leakage amounts and therefore the sound pressure subjected to the ear. A “sealed” interface allows the ear to experience the highest sound pressures—loudest when completely sealed. Usually there is some leakage caused by gaps in the headset ear cushion or the ear tip not entirely touching the ear.

Acoustical quality calculations related to sound pressure are conventionally performed assuming a worst-case condition in terms of highest sound pressures subjected to the user, which are achieved through best-case sealing, which in turn implies that there are no gaps around the ear interface. Following this conservative approach, the conventional headset's analysis of receiver signal and best-fit ear coupling may assume higher sound pressure levels than the user is really experiencing. Since TWA analysis is used to force the headset volumes down before the user becomes over-exposed to long durations of high sound pressures, a headset can become too quiet for the user even though the user has not been exposed to sound pressures that warrant reduction.

Accordingly, embodiments of the invention involve monitoring touch points about the perimeter where the audio device engages the body to determine whether the audio device has been adequately sealed to the body. A variety of engagement sensors may be employed, according to embodiments of the invention. For example, capacitive sensing techniques may be employed to determine if and/or when the audio device has successfully formed an appropriate closure with the ear. Capacitance touch sensing comprises a technical implementation that involves monitoring many different “touch points” to determine if and/or when the audio device (e.g., ear cushion or ear tip) is appropriately engaged with the user's ear (e.g., a complete circumference around the user's ear), according to an embodiment of the invention. In addition, this seal status determination information can enable headset designs otherwise unable to offer TWA.

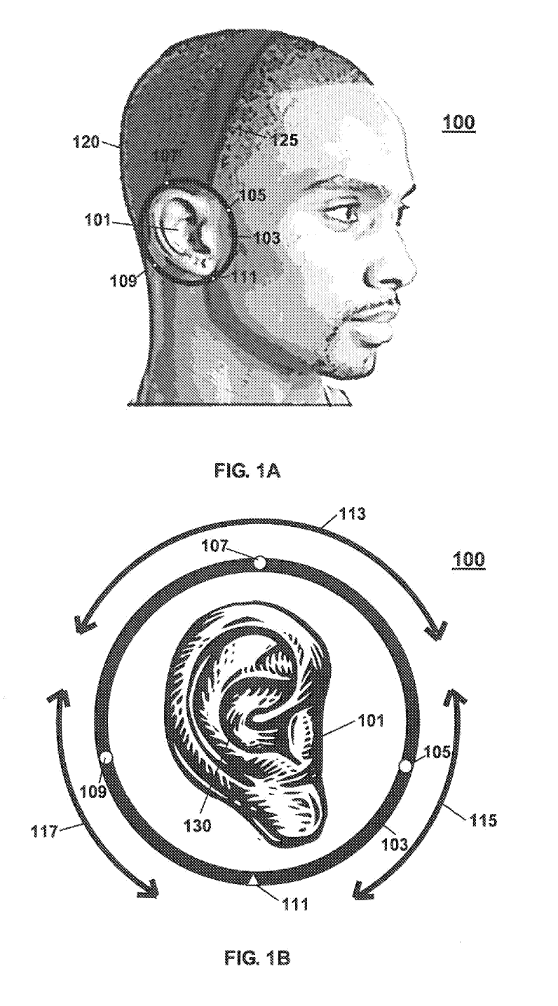

FIG. 1A illustrates a headphone system 100 comprising a headphone 125 having a plurality of engagement sensors 105-109, according to an embodiment of the invention. The engagement sensors 105-109 detect whether an ear piece 103 has been appropriately coupled to a listener's head 120 around the ear 101. The engagement sensors 105-109 are located along a periphery of the ear piece 103, according to an embodiment of the invention. Depending on the precise design of the headphone 125, the engagement sensors 105-109 may be located in an ear cushion portion of the ear piece 103.

The ear piece 103 shown in FIG. 1A is depicted in a cutaway view. Many conventionally operative portions of the earpiece 103 have been removed in order to illustrate engagement of the earpiece 103 around the user's ear 101 when the headset 125 is properly worn. As discussed below, optimal wearing of the headset 125 typically means engaging the earpiece 103 with the user's head 120 but for a leakage port 111, according to an embodiment of the invention.

The engagement sensors 105-109 may be dispersed about the ear piece 103 to provide complete coverage around the earpiece 103 as it engages with the user's head 120, according to an embodiment of the invention. As shown in FIG. 1A, the engagement sensors 105-109 have been equally dispersed around the perimeter of the ear piece 103; however, other geometries for location of the sensors 105-109 are possible in accordance with other embodiments of the invention. Embodiments of the invention employ capacitive touch sensors as the engagement sensors 105-109 to detect when the earpiece 103 is appropriately engaged with the user's head 120. Other types of engagement sensors may be used in accordance with the spirit of the invention. For example, RF link sensors may be employed in place of capacitive touch sensors, according to an embodiment of the invention. The engagement sensors may even comprise a mix of sensor types, according to embodiments of the invention.

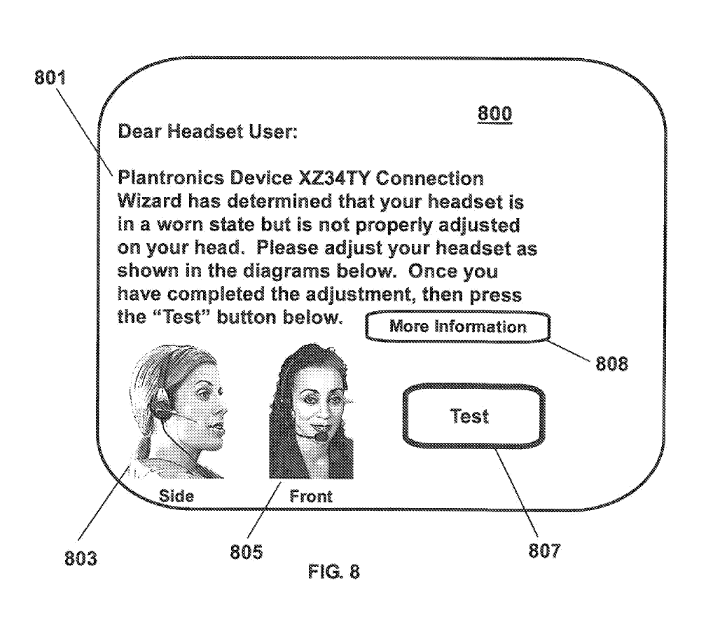

Knowledge by the headphone system 100 of the engagement of the earpiece 103 to the user's head 120 provides status information to the headphone system 100 that may be used for several purposes, including acoustical quality calculations, according to embodiments of the invention. Knowledge of the engagement (or non-engagement) of the earpiece 103 to the user's head 120 allows the headset system 100 to turn on/off TWA, thus enabling the possibility of improved sound quality being delivered to the user by the headphone 125. Knowledge of the engagement (or non-engagement) of the earpiece 103 to the user's head 120 allows the headphone system 100 to provide an appropriate status indication to the user (e.g., the status indication 800 shown in FIG. 8), according to various embodiments of the invention. Knowledge of the engagement (or non-engagement) of the earpiece 103 with the user's head 120 enables the headset system 100 to turn on/off active noise cancellation, according to embodiments of the invention. Knowledge of the engagement (or non-engagement) of the ear piece 103 with the user's head 120 enables the headset system 100 to adjust sound pressures in the earpiece 103 commensurate with the level of engagement between the ear piece 103 and the user's head 120, according to embodiments of the invention. Similarly, knowledge of the engagement (or non-engagement) of the ear piece 103 with the user's head 120 allows the headphone system 100 to adjust frequency response in the ear piece 103 commensurate with the level of engagement between the ear piece 103 and the user's head 120, according to an embodiment of the invention.

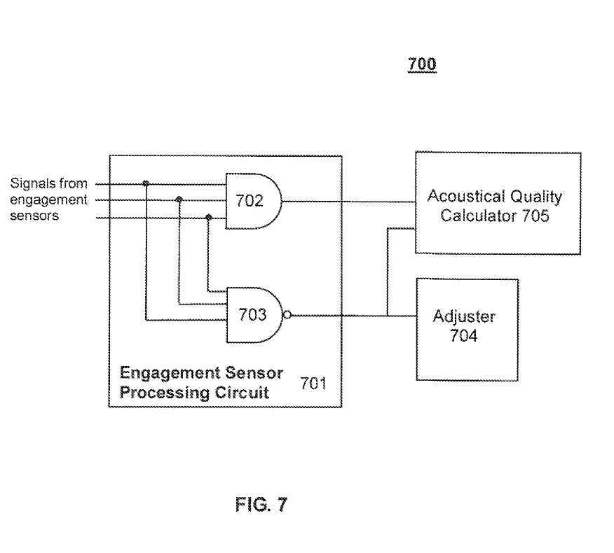

Audio devices, such as the headphone 125, are conventionally designed to lessen the occurrence of adverse acoustic experiences, such as acoustic shock. Acoustic shock comprises the symptoms a person may experience after hearing an unexpected, loud noise from a sound-producing device, such as the headphone 125. The typical headset user experiences discomfort and pain when exposed to acoustic shock. On occasion, acoustic shock may require medical treatment. As discussed in FIG. 5, signals directed to the headphone 125 are first received and processed by equipment (e.g., a digital signal processor) configured to remove potentially harmful sounds before they reach the user, according to an embodiment of the invention. The sound processing equipment (e.g., the DSP) may improve its sound processing capabilities with knowledge gained from the engagement sensors 105-109 regarding the engagement of the audio device with the user's body. Among other things, the sound processing equipment may select an appropriate frequency-shaping algorithm based upon the location(s) of the engagement sensors 105-109 that touch the user's head 120. FIG. 7 describes an engagement sensor processing circuit 701 that may be employed to receive and process signals from the engagement sensors 105-109, according to an embodiment of the invention.

The ear piece 103 includes a controlled leakage port 111, according to an embodiment of the invention. The presence of the leakage port 111 may further reduce the impact of acoustic shock by reducing the maximum potential for sound pressures within the earpiece 103. A leakage port is conventionally employed in headphone design as a means for intentionally permitting some leakage, usually via a tuned port (e.g., the leakage port 111), so that ear-to-device interface variations cause fewer impacts on overall headphone system 100 performance. The controlled leakage port 111 is designed to keep the earpiece 103 from sealing completely to the user's head 120. Enabling a predetermined amount of leakage conventionally provides an overall enhancement to headphone 125 sound quality.

The engagement sensors 105-109 may be formed in part of an electrically conductive material such as a capacitive sensor, according to an embodiment of the invention. The electrically conductive element of a capacitive engagement sensor may either contact the user's head 120 or be sufficiently close to the user's ear 101 to permit detection of capacitance in embodiments of the invention that employ capacitance sensing. A capacitive engagement sensor may comprise an electrode while the user's head and/or ear may be considered the opposing plate of a capacitor with the capacitance Ce. A touch sensing system is electrically connected to the electrode, and the touch sensing system determines whether the electrode is touching or in close proximity to the user's head and/or ear based on the capacitance Ce when the electrode is touching or close to the head/ear and when the electrode is not. When the electrode is touching or in close proximity to the skin of the user's head/ear, an increase in relative capacitance may be detected.

The touch sensing system can be located in an apparatus such as a printed circuit board (PCB), according to an embodiment of the invention, and there is parasitic capacitance between the electrode and the PCB ground plane which may be illustrated as Cp. The capacitance between the user's ear and the electrode is indicated as Ce, and Cu indicates the capacitance between the PCB ground plane and the user. Assuming that Cp is negligible or calibrated for, the total capacitance seen by the touch sensing system is the series capacitance of the electrode to the ear, Ce, and the head to the system, Cu. The capacitive connection of the user to the system ground Cu is often a factor of 10 or more than the capacitance of the ear to the electrode Ce, so that the Ce dominates, according to an embodiment of the invention.

Use of capacitive touch sensing systems is further discussed in the commonly assigned and co-pending U.S. patent application Ser. No. 12/501,961 entitled “Speaker Capacitive Sensor” (Attorney Docket No.: 01-7563), which was filed on Jul. 13, 2009 and U.S. patent application Ser. No. 12/060,031 entitled “User Authentication System and Method” (Attorney Docket No.: 01-7437), which was filed on Mar. 31, 2008, and both of which are hereby incorporated into this disclosure in its entirety by reference.

FIG. 1B illustrates relative and overlapping coverage ranges 113-117 for the engagement sensors 105-109 of the headphone system 100, according to an embodiment of the invention. As shown in FIG. 1B, the engagement sensors 105-109 provide multiple touch points (three overlapping ranges 113-117 around the ear piece 103), according to an embodiment of the invention. The overlapping ranges 113-117 of the engagement sensors 105-109 provide additional data that can be used to determine that the user has the headphone 125 appropriately positioned against the head 120. The ear piece 103 optimally has the user's concha (or ear hole) 130 as its center, according to an embodiment of the invention. Geometries for the ranges 113-117 have been equally distributed about the periphery of the earpiece 103, as shown in FIG. 1B; however, other distribution geometries could be employed in various embodiments of the invention, depending upon the characteristics specific engagement sensors deployed and/or sensitivities of particular engagement locations.

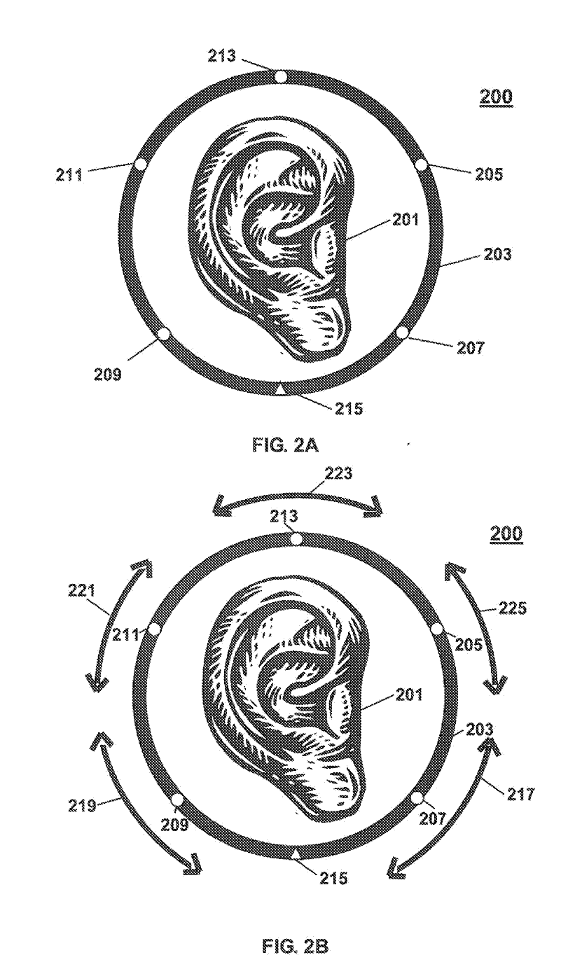

FIG. 2A illustrates an embodiment of a headphone system 200 having five engagement sensors 205-213, according to an embodiment of the invention. While the embodiment of the invention shown in FIG. 2A has five engagement sensors 205-213, other embodiments of the invention may employ fewer or more engagement sensors. The number of engagement sensors deployed may depend upon a number of factors, such as the data needs of the headphone's digital signal processor and the desired level of accuracy with respect to determining that the user is wearing the earpiece 203 properly. The accuracy of the specific engagement sensors employed may also impact the number of sensors that may be needed.

The system 200 shown in FIG. 2A also includes a leakage port 215. As discussed above, a leakage port is a commonly used technique in headset design that intentionally permits some leakage, usually via a tuned port (e.g., the leakage port 215), so that the ear-to-device interface variations are less impactful on overall system 200 performance. The headphone system 200 may otherwise resemble the headphone system 100 shown in FIGS. 1A-B, according to an embodiment of the invention.

FIG. 2B illustrates relative and overlapping ranges 217-225, associated with the five engagement sensors 205-213 of the headphone system 200, according to an embodiment of the invention. Having the ranges 217-225 of the sensors 205-213 overlap may improve the accuracy of the readings reported to the digital signal processor (e.g., DSP 500 shown in FIG. 5). As previously discussed, the employment of additional engagement sensors may improve the quality of the data measured and/or provide the same coverage as a smaller number of sensors if/when the sensors deployed (e.g., the headphone system 100 versus the headphone system 200) have different sensitivities.

Knowledge by the headphone system 200 of the engagement of earpiece 203 to the user's head provides information to the headphone system 200 that may be used for several purposes including acoustical quality calculations, according to embodiments of the invention. Knowledge of the engagement (or non-engagement) of the earpiece 203 to the user's head allows the headphone system 200 to turn on/off TWA, thus enabling the possibility of improved sound quality being delivered to the user. Knowledge of the engagement (or non-engagement) of the earpiece 203 to the user's head allows the headphone system 200 to provide an appropriate status indication to the user, according to various embodiments of the invention. Knowledge of the engagement (or non-engagement) of the earpiece 203 with the user's head enables the headphone system 200 to turn on/off active noise cancellation, according to embodiments of the invention. Knowledge of the engagement (or non-engagement) of the ear piece 203 with the user's head allows the headphone system 200 to adjust sound pressures in the earpiece 203 commensurate with the level of engagement between the ear piece 203 and the user's head, according to embodiments of the invention. Similarly, knowledge of the engagement (or non-engagement) of the ear piece 203 with the user's head allows the headphone system 200 to adjust frequency response in the ear piece 203 commensurate with the level of engagement between the ear piece 203 and the user's head, according to an embodiment of the invention.

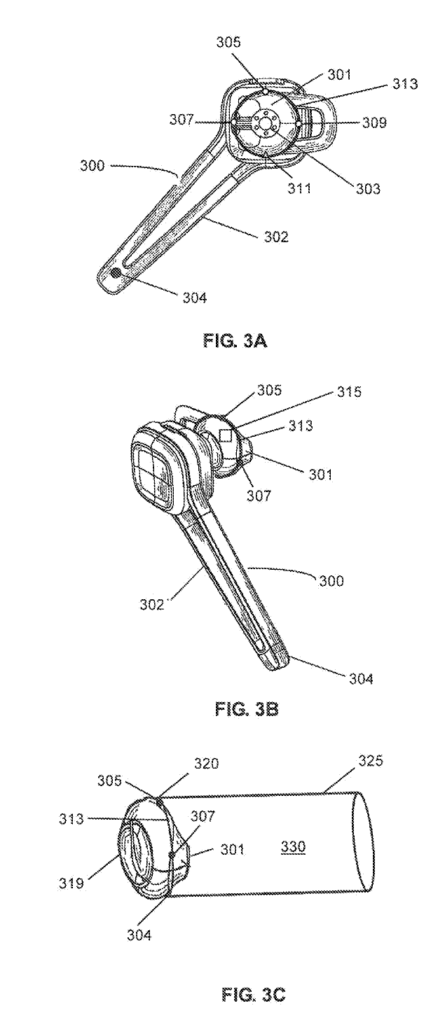

FIGS. 3A-3B illustrate two views of an earbud system 300 having three engagement sensors 305-309, according to an embodiment of the invention. While sensing proximity to a user's head may be performed in various places on a headset, for an earbud (e.g., the earbud system 300) the portion that goes into the user's ear (e.g., portion 319 shown in FIG. 3C) represents a location that indicates if the earbud system 300 is being worn. A speaker portion 303 for many headsets is typically close to the user's concha (e.g., ear opening), and likely provides an optimal region for sensing that the earbud system 300 is worn. The earbud system 300 comprises engagement sensors 305-309, according to an embodiment of the invention. Other embodiments of the earbud system 300 may have different numbers of engagement sensors within the spirit of the invention; e.g., just as headphone system 100 and headphone system 200 respectively employ different sets of engagement sensors.

The earbud system 300 also comprises a body 302, a microphone 304, and an earpiece 301, according to an embodiment of the invention. The earpiece 301 may, for example, be composed of a soft flexible material such as rubber to conform to the user's ear when the earbud system 300 is donned by the user. These components of the earbud system 300 may be of a conventional design and need not be discussed in detail as they are known to an ordinary artisan.

Ear sizes vary among people, including characteristics such as concha size and outer ear size. Accordingly, conventional earbuds may include interchangeable tips of various sizes in order to allow users to select a tip that provides an optimal auditory experience and comfort. Some conventional ear bud systems provide users with as many as three geometries of ear engagement tips with each ear bud unit in order for users to select a tip that achieves a good seal. Many users unfortunately do not take the time to find the proper ear bud geometry for the ear engagement piece, and their user experience is often less positive than it could be. Embodiments of the earbud system 300 may also be used with interchangeable tips of various sizes. In such an embodiment, the engagement sensors 305-309 would be deployed around the ear bud tip.

The earbud system 300 shown in FIGS. 3A-3B includes an inflatable ring 313, according to an embodiment of invention. The earbud system 300 includes an actuator 315 configured to inflate the ring 313 in response to indications from the sensors 305-309 that the user's concha 320 (shown in FIG. 3C) is not appropriately touching the earbud system 300. The actuator 315 inflates the ring 313 in diameter until the engagement sensors 305-309 report an appropriate connection to the concha 320, according to an embodiment of the invention. The actuator 315 may operate automatically and/or in a manual embodiment engaged by the user.

The earbud system 300 may alternatively include a dial (not shown) whose actuation by the user engages the actuator 315 and causes the ring 313 to inflate or deflate, depending, for example, on which direction the user turns the dial. Alternatively, the earbud system 300 may operate in an automatic manner by, among other approaches, periodically sampling engagement sensors 305-309 to determine if they report a good seal with the user's concha 320, as shown in FIG. 3C, and making appropriate adjustments if the engagement sensors 305-309 do not report an appropriate engagement.

FIG. 3C illustrates a sealed cavity 330 formed by inserting a portion 319 of the earbud 301 into the user's ear canal 325, according to an embodiment of the invention. In donning the earbud 300 (shown fully in FIGS. 3A-3B), the user typically inserts the portion 319 of the earpiece 301 into the concha 320 of the user's ear. The earpiece 301 typically fits snugly in the concha 320 so that the earbud 300 is supported by the user's ear, according to an embodiment of the invention. Only the portion 319 of the ear bud 301 is shown in FIG. 3C for illustrative purposes. The earbud system 300 allows accurate sound pressures to be preserved in the sealed cavity 330 formed by the ear canal 325 and the portion 319. The portion 319 of the earbud 301 engaging with the user's concha 320 may in some embodiments be the inflatable ring 313. The fit can be improved by engagement of the ring 313 with the ear as previously discussed. The concha 320 is a proper name for the more conventional “ear hole.”

The more accurate sound pressures enabled by the arrangement shown in FIG. 3C further enable more precise acoustical quality calculations by the acoustic processing equipment associated with the earbud system 300, such as the digital signal processor 500 shown in FIG. 5, according to an embodiment of the invention.

The earbud system 300 also includes a leakage port 311. The leakage port 311 serves a similar function to the leakage port 111 shown in FIG. 1A. However, because of the different surface contours between the user's head and the concha 320, the leakage port 311 may need to be located in a slightly different position than the leakage port 111 shown in FIG. 1A. For example, an optimal position for the leakage port 311 may lie in a slightly different plane than the sensors 305-309, according to an embodiment of the invention.

Knowledge by the earbud system 300 of the engagement of the ear bud 301 to the user's concha 320 provides information to the earbud system 300 that may be used for several purposes, such as acoustical quality calculations, according to embodiments of the invention. Knowledge of the engagement (or non-engagement) of the ear bud 301 to the user's concha 320 allows the earbud system 300 to turn on/off TWA, thus enabling the possibility of improved sound quality being delivered to the user. Knowledge of the engagement (or non-engagement) of the ear bud 301 to the user's concha 320 allows the earbud system 300 to provide an appropriate status indication to the user, according to various embodiments of the invention. Knowledge of the engagement (or non-engagement) of the ear bud 301 with the user's concha 320 enables the earbud system 300 to turn on/off active noise cancellation, according to embodiments of the invention. Knowledge of the engagement (or non-engagement) of the ear bud 301 with the user's concha 320 enables the ear bud system 300 to adjust sound pressures in the ear bud 301 commensurate with the level of engagement between the ear bud 301 and the user's concha 320, according to embodiments of the invention. Similarly, knowledge of the engagement (or non-engagement) of the ear bud 301 with the user's concha 320 allows the earbud system 300 to adjust frequency response in the ear bud 301 commensurate with the level of engagement between the ear bud 301 and the user's concha 320 (e.g., the application of an appropriate frequency shaping algorithm), according to an embodiment of the invention.

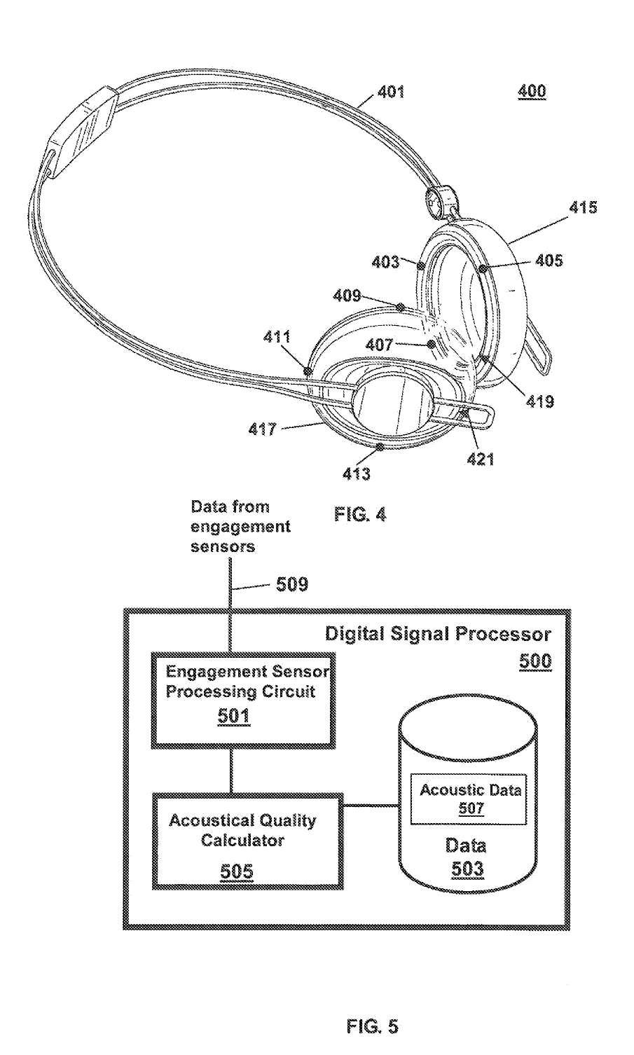

Embodiments of the invention are applicable to dual headsets as well as single headsets. FIG. 4 illustrates a dual headphone system 400 having six engagement sensors 403-413 on a headphone 401 having two earpieces 415, 417, according to an embodiment of the invention. Three engagement sensors 403-407 are deployed on the first earpiece 415 while three other engagement sensors 409-413 are deployed on the second earpiece 417, according to an embodiment of the invention. Each earpiece 415, 417 also includes leakage ports 419, 421.

The engagement sensors 403-407 on the earpiece 415 operate in a similar manner to the engagement sensors 105-109 shown in FIG. 1A, as do the engagement sensors 409-413 on the earpiece 417. Similarly, the leakage port 419 on the first earpiece 415, and the leakage port 421 on the second earpiece 417 operate in a manner similar to the leakage port 111 shown in FIG. 1A, according to an embodiment of the invention.

The dual headphone system 400 may use data received from the engagement sensors 403-413 to trigger a variety of acoustical quality calculations, such as those discussed with respect to the headphone system 100 in FIGS. 1A-1B. For example, the dual headphone system 400 may operate in conjunction with a single digital signal processor (DSP) that handles inputs from all engagement sensors 403-413 or dual DSPs configured such that one DSP handles signals from the sensors 403-407 of the first earpiece 415 while the second DSP handles signals from the sensors 409-413 of the second earpiece 417, according to an embodiment of the invention. Still other embodiments of the invention may employ a different number of DSPs, as would be suggested to an average artisan working in the field.

FIG. 5 illustrates a digital signal processor (DSP) 500 configured to provide digital signal processing of audio signals destined for output to a headphone's speaker(s) and configured to process signals received from engagement sensors associated with headphones and earbuds, according to an embodiment of the invention. For example, the DSP 500 could be associated with the headsets 100, 200, 300, and/or 400 discussed in connection with the embodiments of the invention shown in FIGS. 1A-4.

The DSP 500 comprises an engagement sensor processing circuit 501 configured to process signals received from the engagement sensors (e.g., the engagement sensors 105-109 shown in FIG. 1A), according to an embodiment of the invention. The DSP 500 also comprises an acoustical quality calculator 505. The acoustical quality calculator 505 is configured to provide the conventional acoustical processing associated with audio devices, including but not limited to processing performed for consumer health and safety reasons. Processing of the acoustical quality calculator 505 may be triggered by various events and actions, including but not limited to a signal from the engagement sensor processing circuit 501 that the audio device is engaged with the user's body (e.g., the user's head or ear, as appropriate).

The engagement sensor processing circuit 501 is configured to process signals 509 received from the engagement sensors associated with a headset, according to an embodiment of the invention. For example, the engagement sensor processing circuit 501 could receive signals 509 sent from the engagement sensors shown in the headset systems 100-400 shown in FIGS. 1A-4, respectively, and process them to determine a respective level of engagement with the user's body, according to an embodiment of the invention. The engagement sensor processing circuit 501 may be constructed in a variety of ways; FIG. 7 illustrates one embodiment for the engagement sensor processing circuit 501.

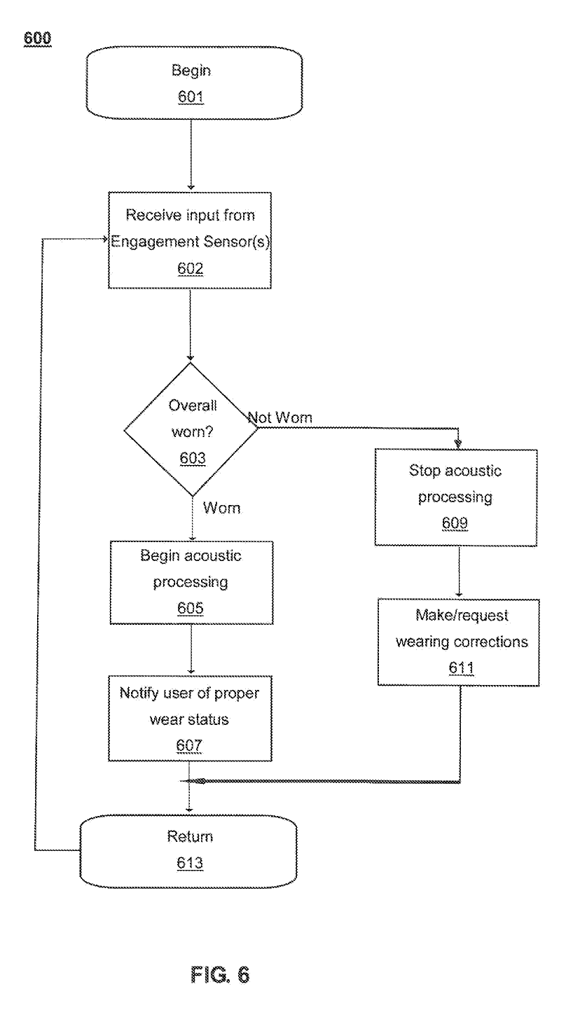

The engagement sensor processing circuit 501 is configured to receive signals 509 from engagement sensors (e.g., the engagement sensors 105-109 shown in FIG. 1A) and determine the degree of seal that the associated headset has with the user's head (or ear canal in the case of an earbud). The engagement sensor processing circuit 501 may execute logic (see, e.g., flowchart 600 shown in FIG. 6) that determines which engagement sensors report engagement with the appropriate part of the user's body. If the engagement sensors report that the headset is appropriately engaged with the user's body (e.g., head or ear, as appropriate), then the engagement sensor processing circuit 501 may determine that the headset is appropriately engaged. Embodiments of the engagement sensor processing circuit 501 may be configured to provide a binary answer to audio device engagement (e.g., an overall “yes” or an overall “no”), or may be configured to provide more precise information, such as a percentage of engagement or disengagement (e.g., 65% engaged).

Knowledge regarding the engagement of the audio device to the user's body provides information that may trigger particular processing steps by the acoustical quality calculator 505, according to embodiments of the invention. Knowledge of the engagement (or degree of non-engagement) of the audio device (e.g., the earpiece 103 shown in FIG. 1A) to the user's body allows acoustical quality calculator 505 to turn on/off TWA processing, thus enabling the possibility of improved sound quality being delivered to the user. Knowledge of the engagement (or degree of non-engagement) of the audio device to the user's body allows the DSP 500 to trigger an appropriate status indication to the user (e.g., the status indication 800 shown in FIG. 8), according to various embodiments of the invention. Knowledge of the engagement (or degree of non-engagement) of the audio device with the user's body enables the acoustical quality calculator 505 to turn on/off active noise cancellation, according to embodiments of the invention. Knowledge of the engagement (or degree of non-engagement) of the audio device with the user's body enables the acoustical quality calculator 505 to adjust sound pressures in the earpiece commensurate with the level of engagement between the audio device and the user's body, according to embodiments of the invention. Similarly, knowledge of the engagement (or degree of non-engagement) of the audio device with the user's body allows the acoustical quality calculator 505 to adjust frequency response in the ear piece commensurate with the level of engagement between the audio device and the user's body, according to an embodiment of the invention.

The acoustical quality calculator 505, for example, may begin computing a time-weight-average (TWA) of the audio outputs directed to a headset equipped with the engagement sensors once the engagement sensors begin reporting proximity data. Otherwise, the DSP 500 may conclude that the headset is not properly engaged and may engage various corrective measures.

Many countries' laws require calculation of measures like TWA in order to determine if a headset is working properly and to avoid problems such as acoustic shock, mentioned previously. Different TWA standards exist in various countries, such as Australia, the European Union, and the US. These differing requirements may include different maximum sound pressures for example. These standards may typically be achieved by adjusting the processing of the acoustical quality calculator 505 and do not necessarily require that physical changes be made to the headset itself (e.g., the headset system 100 shown in FIG. 1). Thus, the physical portion of the ear interface can typically remain unchanged with the overall device still satisfying the appropriate national/regional standard with any necessary acoustic changes coming from various versions of the acoustical quality calculator 505, according to an embodiment of the invention. Accordingly, the acoustical quality calculator 505 conventionally bears much of the audio device's compliance burden.

The presence of engagement sensors, such as the engagement sensors 105-109 shown in FIG. 1A, may allow for a more accurate determination of TWA, providing a better user experience and improved compliance with various global standards. Among other things, the presence of the engagement sensors may allow the DSP 500 to better understand when it can meaningfully perform TWA calculations. For example, the DSP 500 may initiate TWA processing once the engagement sensor processing circuit 501 has determined that the headset is actually engaged with the appropriate body part (head or ear canal) of the user, according to an embodiment of the invention. The acoustical quality calculator 505 conventionally makes regular acoustic samples during the worn state. Techniques for performing TWA calculations themselves can be found in other documents; embodiments of this invention pertain to the engagement of sound quality and improvement mechanisms, such as TWA, rather than the performance of these techniques per se.

The DSP 500 may be configured using a variety of computer chips and other processing systems. For example, the Cypress touchsensing chip, the Bluetooth touchsensing chip, and the CSR BlueCore chips may all represent appropriate chips for the DSP 500, according to an embodiment of the invention. Other chips may provide appropriate processing, however, according to various embodiments of the invention.

FIG. 6 provides a flowchart 600 that shows processing logic carried out by the engagement sensor processing circuit 501 and the acoustical quality calculator 505 of the DSP 500 shown in FIG. 5 related to the processing of signals from engagement sensors, according to an embodiment of the invention. As previously mentioned, the DSP 500 comprises an acoustical quality calculator 505 that provides auditory control of headsets, e.g., the headset system 100 shown in FIG. 1A and the earbud system 300 shown in FIG. 3.

The engagement sensor processing circuit 501 receives (step 602) input from the headset's engagement sensor(s) that indicates the headset's engagement state from each engagement sensor's point of view (e.g., the engagement sensor 105 shown in FIG. 1A). The engagement sensors may be configured to communicate their state continuously or only when their state changes, according to various embodiments of the invention. The engagement sensor processing circuit 501 primarily concerns itself with state changes in determining the worn state of the headset, according to an embodiment of the invention.

The engagement sensor processing circuit 501 conducts a regular sampling of the headset's worn state to determine whether the engagement sensors' outputs indicate an overall worn (or donned/doffed) state (step 603), according to an embodiment of the invention. For example, if all the engagement sensors report engagement, then the headset may be considered engaged. The worn state may be gauged by determination that the sensors are reporting a capacitance in the range of 40-50 pF. If the headset employs a capacitive sensor as the engagement sensor, and the engagement sensor processing circuit 501 receives from the engagement sensors a capacitance in the range of 30-35 pF, then the engagement sensor processing circuit 501 may possibly check the sensors again, before determining that the user is likely not wearing the headset, according to an embodiment of the invention.

If the engagement sensor processing circuit 501 determines an overall worn state (step 603), then the acoustical quality calculator 505 may begin various acoustical processes related to the headset (step 605). As discussed above, these acoustical processes may include TWA, active noise cancellation, sound pressure adjustments, and/or frequency adjustments, according to various embodiments of the invention. Thus, the overall worn state typically indicates that the headset is worn sufficiently such that acoustical processing can meaningfully be performed, although in some embodiments, this state may imply the application of various corrective measures (such as frequency shaping algorithms) to compensate for some engagement sensors reporting a non-engaged state, according to an embodiment of the invention.

The DSP 500 may alternatively provide notification to the user that the headset is properly worn and/or the degree to which the headset is worn (step 607), according to an embodiment of the invention. The DSP 500 returns (step 613) to periodic monitoring of engagement sensor signals (step 602), according to an embodiment of the invention. Reporting the degree to which the headset is worn allows the user to make corrections to the headset's wear state even if the headset is already sufficiently worn for acoustic processing to be performed.

If the engagement sensor processing circuit 501 determines that the engagement sensor's output indicates an overall not worn state (step 603), then the acoustical quality calculator 505 may stop calculating various acoustical processes for the headset (step 609) if the acoustical quality calculator 505 was presently collecting such data. As discussed above, these acoustical processes may include TWA, active noise cancellation, sound pressure adjustments, and/or frequency adjustments, according to various embodiments of the invention. The acoustical quality calculator 505 may also delete old acoustical data at this point, according to an embodiment of the invention. The acoustical quality calculator 505 may also make corrections and/or request corrections from the user (step 611), such as the corrections discussed in FIG. 8.

After processing received signals from the engagement sensors, the DSP 500 returns (step 613) to a state (step 602) of waiting for further signals from the engagement sensors. The processing provided by the DSP 500 typically continues indefinitely, so long as the headset has an operable power supply and is turned on.

FIG. 7 illustrates an engagement sensor processing circuit 700 configured to process signals received from engagement sensors, according to an embodiment of the invention. The circuit 700 comprises an engagement sensor circuit 701, an acoustical quality calculator 705, and an adjuster 704, according to an embodiment of the invention.

The engagement sensor processing circuit comprises two AND gates 702, 703. The AND gate 703 also includes an inverse element such that outputs from the AND gate 703 will always read oppositely of the output of AND gate 702.

When all signals from the engagement sensors flowing into the AND gate 702 report a positive signal (indicating engagement), then the AND gate 702 will output a positive signal to the acoustical quality calculator 705, according to an embodiment of the invention. This positive signal tells the acoustical quality calculator 705 that the audio device is engaged with the user's body. The acoustical quality calculator 705 may begin performing its acoustical calculations in the conventional manner.

Conversely, output from the AND gate 703 after being inverted will provide a positive signal except when all initial inputs from the engagement sensors are positive (meaning that the sensors have found that the audio device is engaged with the body). A positive signal from the AND gate 703 may engage processing of an adjuster 704 configured to help the user better engage the audio device with the body, according to an embodiment of the invention.

The acoustical quality calculator 705 may comprise a digital signal processor configured to perform the acoustical quality calculations previously discussed. The acoustical quality calculator 705 may comprise components such as a CPU configured to perform the equations related to acoustical quality. The acoustical quality calculator 705 may comprise additional components geared to determine a percentage of overall engagement, e.g., how many engagement sensors report proper engagement with the user's head.

As shown in FIG. 7, the AND gates 702 and 703 comprise three inputs, representing outputs from three engagement sensors. A conventional AND gate typically receives just two inputs. Thus, an embodiment of the AND gates 702, 702 may each be implemented with two conventional AND gates, with a first AND gate processing outputs from two engagement sensors and a second AND gate processing outputs from the first AND gate and a third engagement sensor, according to an embodiment of the invention. The logic for AND gates 702, 703 is that the gates will only produce a positive output signal when all three input signals are active; otherwise, only the AND gates will produce a negative signal.

FIG. 8 illustrates a help screen 800 provided to users whose headsets have been determined to not be worn in an optimal manner (see, e.g., step 611 of FIG. 6), according to an embodiment of the invention. The help screen 800 could be presented to the user on a computer monitor associated with the user/headset, on a telephone interface, and/or on other screens, includes ones associated with other headset functionality. For example, the help screen 800 could be provided on a smartphone, a laptop computer, and/or a tablet computing device.

The help screen 800 includes a message 801 that informs the user that the headset is not properly adjusted on the user's head, according to an embodiment of the invention. The message 801 further directs the user to two figures, one in profile 803 and one head-on 805, that illustrate proper positioning of the headset, according to an embodiment of the invention. Different figures and optimal positions may be provided to the user than the figures shown on the help screen 800, according to an alternative embodiment of the invention.

A button 808 may be included that provides further headset information for the user, according to an embodiment of the invention. A test button 807 may also be provided so that the user can check to see if the headset is properly positioned after making the recommended adjustments, according to an embodiment of the invention. The test button 807, among other things, does not necessarily need to be provided since the functionality for determining the headset orientation may operate continuously (see, e.g., flowchart 600 shown in FIG. 6), according to an embodiment of the invention.

The head-on figure 805 and/or the profile figure 803 could alternatively be configured to display which portion of the headset is not properly seated and/or which party is properly seated on the user's head, according to an embodiment of the invention. For example, a section of the headset that is not properly seated could be highlighted in a bright color. As another example, a figure like FIG. 1A could be provided to the user that would show which engagement sensors were reporting non-engagement, according to an embodiment of the invention.

An alternative to the approach provided in FIG. 8 is to provide verbal notification to the user, according to an embodiment of the invention. For example, a small data file could be provided with the headset that would either provide a message of “device worn correctly” or, as appropriate, a message of “device worn incorrectly.” This message could be configured to play over the audio device's speakers.

The help screen 800 may also comprise additional functionality for turning off the help screen, according to an embodiment of the invention. This additional functionality may prove convenient for those instances where the user is intentionally wearing the audio device in a half-on/half-off manner.

The various mechanisms for determining when a user is wearing a headset device disclosed herein may operate independently of other systems configured to determine when a user is utilizing one or both speakers of a dual headset system. These differing applications may employ some similar components (e.g., the engagement sensors), but the goals of these systems differ significantly. Embodiments of the invention provide enhanced sound quality to users by, among other things, more accurately and precisely calculating the TWA equations.

In alternative embodiments of the invention, the engagement sensors may operate by detecting kinetic energy and/or temperature at the headset system to determine if the headset is in a donned condition or a doffed condition.

While specific embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims. In general, in the following claims, the terms used should not be construed to limit the invention to the specific embodiments disclosed in the specification, but should be construed to include all systems and methods that operate under the claims set forth hereinbelow. Thus, it is intended that the invention covers the modifications and variations of this invention provided they come within the scope of the appended claims and their equivalents.

We claim:

1. An audio device engaging acoustical quality calculations based on a user wearing state, comprising:
A plurality of engagement sensors attached to the audio device, each engagement sensor configured to measure a worn state, where each measured worn state indicates whether the audio device touches a portion of the user's body, and transmit the worn state to an engagement sensor processing circuit; and
An engagement sensor processing circuit configured to receive a plurality of worn states from the plurality of engagement sensors, determine if the user is wearing the audio device based on analysis of the plurality of worn states, and engage acoustical quality calculations for the audio device if the user is determined to be wearing the audio device.

2. The audio device of claim 1 wherein the portion of the user's body touched by the audio device is the user's head and wherein the plurality of engagement sensors are configured to measure if the audio device touches the user's head.

3. The audio device of claim 2 wherein the audio communication system further comprises:
A leakage port configured to restrain pressures in a cavity formed by the audio device and a portion of the user's head near the ear.

4. The audio device of claim 2 wherein at least a portion of the plurality of engagement sensors comprise capacitive sensors.

5. The audio device of claim 2 wherein engagement sensors of the plurality of engagement sensors are located around a perimeter of a portion of the audio device that engages with the user's head.

6. The audio device of claim 5 wherein engagement sensors of the plurality of engagement sensors are evenly located around the perimeter of the audio device.

7. The audio device of claim 5 wherein the plurality of engagement sensors comprises at least three engagement sensors.

8. The audio device of claim 5 wherein engagement sensors of the plurality of engagement sensors have overlapping sensing ranges.

9. The audio device of claim 2 wherein the engagement sensor processing circuit engages a correction mechanism when the user is determined not to be wearing the audio device.

10. The audio device of claim 9 wherein the correction mechanism is configured to provide the user with instructions regarding proper wearing locations for the audio device.

11. The audio device of claim 9 wherein the correction mechanism includes a user-engageable test mechanism configured to determine if the audio device is properly worn.

12. The audio device of claim 1 wherein the engagement sensor processing circuit stops acoustical quality calculations for the audio device when the user is determined to be not wearing the audio device appropriately.

13. The audio device of claim 1 wherein the portion of the user's body touched by the audio device is the user's ear and wherein the plurality of engagement sensors are configured to determine if the audio device forms a seal with a concha of the user's ear.

14. The audio device of claim 13 wherein the audio communication system further comprises:
A leakage port configured to restrain pressures in a cavity formed by the audio device and the user's ear canal.

15. The audio device of claim 13 wherein at least a portion of the plurality of engagement sensors comprise capacitive sensors.

16. The audio device of claim 13 wherein the audio device includes an inflatable ring where the audio device engages with the user's concha.

17. The audio device of claim 13 wherein engagement sensors of the plurality of engagement sensors are located around a perimeter of the audio device that engages with the user's ear.

18. The audio device of claim 17 wherein engagement sensors of the plurality of engagement sensors are evenly located around the perimeter of the audio device.

19. The audio device of claim 17 wherein the plurality of engagement sensors comprises at least three engagement sensors.

20. The audio device of claim 17 wherein engagement sensors of the plurality of engagement sensors have overlapping sensing ranges.

21. The audio device of claim 13 wherein the engagement sensor processing circuit engages a correction mechanism when the user is determined not to be properly wearing the audio device.

22. The audio device of claim 21 wherein the correction mechanism is configured to provide the user with instructions regarding proper wearing locations for the audio device.

23. The audio device of claim 21 wherein the correction mechanism includes a user-engageable test mechanism configured to determine if the audio device is properly worn.

24. The audio device of claim 13 wherein the engagement sensor processing circuit stops acoustical quality calculations for the audio device when the user is determined to be not wearing the audio device appropriately.

25. The audio device of claim 1 wherein the engagement sensor processing circuit is included in a digital signal processor.

26. The audio device of claim 25 wherein the digital signal processor is configured to perform acoustical quality calculations for the audio device.

27. The audio device of claim 26 wherein the digital signal processor is configured to calculate acoustic quality characteristics of the audio device comprising at least one of a time-weighted average, active noise cancellation, adjustment of sound pressures in the audio device commensurate with the level of engagement, and adjustment of the frequency response in the audio device commensurate with the level of engagement.

28. A method for initiating acoustical quality calculations in an audio device based on a user wearing state, comprising:
Measuring a worn state by each engagement sensor of a plurality of engagement sensors attached to the audio device, wherein the worn state represents the engagement sensor's proximity to a portion of the user's body that the audio device touches when used;
Transmitting measurement data from each engagement sensor of the plurality of engagement sensors to an engagement sensor processing circuit;
Determining if the user is wearing the audio device by the engagement sensor processing circuit by confirming that each engagement sensor of the plurality of engagement sensors reports that the audio device is in a worn state; and
Engaging acoustical quality calculations for the audio device if the engagement sensor processing circuit determines that the audio device is in a worn state.

29. The method of claim 28 wherein the portion of the user's body is the user's head and wherein the plurality of engagement sensors are configured to measure if the audio device touches the user's head.

30. The method of claim 28 further comprising:
Restraining pressures in a cavity formed by the audio device and a portion of the user's head near the ear using a leakage port.

31. The method of claim 28 wherein at least a portion of the plurality of engagement sensors comprise capacitive sensors.

32. The method of claim 28 wherein engagement sensors of the plurality of engagement sensors are located around a perimeter of a portion of the audio device that engages the user's head.

33. The method of claim 32 wherein engagement sensors of the plurality of engagement sensors are evenly located around the perimeter of the audio device.

34. The method of claim 32 wherein the plurality of engagement sensors comprises at least three engagement sensors.

35. The method of claim 32 wherein engagement sensors of the plurality of engagement sensors have overlapping sensing ranges.

36. The method of claim 28, further comprising:
Engaging a correction mechanism by the engagement sensor processing circuit when the user is determined not to be properly wearing the audio device.

37. The method of claim 36, further comprising:
Providing the user with instructions regarding proper wearing locations for the audio device by the correction mechanism.

38. The method of claim 36, further comprising:
Testing if the audio device is properly worn using a user-engageable test mechanism associated with the correction mechanism.

39. The method of claim 28, further comprising:
Terminating acoustical quality calculations for the audio device by the engagement sensor processing circuit when the user is determined to be not wearing the audio device properly.

40. The method of claim 28 wherein the portion of the user's body that the audio device engages is the user's ear and wherein the plurality of engagement sensors are configured to determine if the audio device forms a seal around a concha of the user's ear.

41. The method of claim 40, further comprising:
Restraining pressures in a cavity formed by the audio device and the user's ear canal using a leakage port.

42. The method of claim 40 wherein at least a portion of the plurality of engagement sensors comprise capacitive sensors.

43. The method of claim 40 wherein the audio device includes an inflatable ring at a point where the user's concha engages with the audio device.

44. The method of claim 40 wherein engagement sensors of the plurality of engagement sensors are located around a perimeter of the audio device that engages with the user's ear.

45. The method of claim 44 wherein engagement sensors of the plurality of engagement sensors are evenly located around the perimeter of the audio device.

46. The method of claim 44 wherein the plurality of engagement sensors comprises at least three engagement sensors.

47. The method of claim 44 wherein engagement sensors of the plurality of engagement sensors have overlapping sensing ranges.

48. The method of claim 40, further comprising:
Engaging a correction mechanism by the engagement sensor processing circuit when the user is determined not to be property wearing the audio device.

49. The method of claim 48, further comprising:
Providing the user with instructions regarding proper wearing locations for the audio device by the correction mechanism.

50. The method of claim 49, further comprising:
Testing if the audio device is properly worn using a user-engageable test mechanism associated with the correction mechanism.

51. The method of claim 40, further comprising:
Terminating acoustical quality calculations for the audio device by the engagement sensor processing circuit when the user is determined to be not wearing the audio device properly.

52. The method of claim 28 wherein the engagement sensor processing circuit is included in a digital signal processor.

53. The method of claim 52 wherein the digital signal processor is configured to calculate acoustic characteristics of the audio device.

54. The method of claim 53 wherein the digital signal processor is configured to calculate acoustic characteristics of the audio device comprising at least one of a time-weighted average, active noise cancellation, adjustment of sound pressures in the audio device commensurate with the level of engagement, and adjustment of the frequency response in the audio device commensurate with the level of engagement.
